(19) United States
(12) Patent Application Publication
(10) Pub. No.: US 2009/0044128 A1
(43) Pub. Date: Feb. 12, 2009

(54) ADAPTIVE PUBLISHING OF CONTENT

(75) Inventors: John S. Baumgarten, San Jose, CA (US); Christopher Brooke Sharp, San Jose, CA (US)

Correspondence Address: FISH & RICHARDSON P.C., PO BOX 1022, MINNEAPOLIS, MN, 55440-1022, US

(73) Assignee: Apple Computer, Inc., Cupertino, CA (US)

(21) Appl. No.: 11/834,475

(22) Filed: Aug. 6, 2007

(51) Int. Cl. G06F 3/00

(52) U.S. Cl. 715/738

(57) ABSTRACT

An original content item and a first derivative content item are stored in a storage, the derivative content item being associated with the original content item. A request is received from a remote device, the request including information about the remote device and an identifier associated with the original content item. The first derivative content item is provided to the remote device upon determining that the remote device has a property that does not match a corresponding property of the original content item, and a second derivative content item that is a derivative of the original content item is generated, the second derivative content item having a property that matches a corresponding property of the remote device. The second derivative content item is provided to the remote device.

### BACKGROUND

This disclosure is related to publishing of content.

On-line photo albums allow users to upload digital photos to an on-line storage of a server computer and share the photos with family members and friends. When the photos are downloaded and viewed on client-devices, the pixel resolutions of the photos do not necessarily match the display resolutions of the client devices. For example, when the photos are taken using a digital camera having a sensor resolution of about ten million pixels, the resolution of the images can be up to, e.g., 3648×2736 pixels. When the images are downloaded and viewed on displays having lower resolutions (e.g., 800×600 or 1600×1200), only portions of the images can be viewed at a given time. In some examples, image viewing programs residing at the client devices may automatically resize the images to match the resolutions of the displays so that the entire images can be viewed on the displays.

### SUMMARY

In general, in one aspect, an original content item and a first derivative content item are stored in a storage, the derivative content item being associated with the original content item. A request is received from a remote device, the request including information about the remote device and an identifier associated with the original content item. The first derivative content item is provided to the remote device upon determining that the remote device has a property that does not match a corresponding property of the original content item, and a second derivative content item that is a derivative of the original content item is generated, the second derivative content item having a property that matches a corresponding property of the remote device. The second derivative content item is provided to the remote device.

Implementations may include one or more of the following features. Storing the first content item and the first derivative content item includes storing a first image and a thumbnail version of the first image in the storage. Storing the first content item and the first derivative content item includes storing a video file and an image associated with the video in the storage. Storing the first content item and the first derivative content item includes storing an audio file and an image associated with the audio file in the storage. In some examples, determining that the remote device has a property that does not match a corresponding property of the original content item includes determining that the remote device has a display resolution that does not match a pixel resolution of the original content item. Generating a second derivative content item includes generating a second derivative content item that has a pixel resolution that matches the display resolution of the remote device. In some examples, determining that the remote device has a property that does not match a corresponding property of the original content item includes determining that the remote device has a spectral resolution that does not match a spectral resolution of the original content item. Generating a second derivative content item includes generating a second derivative content item that has a spectral resolution that matches the spectral resolution of the remote device.

In some examples, determining that the remote device has a property that does not match a corresponding property of the original content item includes determining that the original content item is encoded according to a first encoding algorithm and the remote device is not capable of decoding the encoded original content item. Generating a second derivative content item includes generating a second derivative content item that is encoded according to a second encoding algorithm that can be decoded by the remote device. Receiving a request from a remote device includes receiving an HTTP request from the remote device. The derivative content items are invalidated when the original content item is modified. For example, the derivative content items are invalidated when a creation date of the original content item is more recent than the creation date of the derivative content items.

In general, in another aspect, an original image and a thumbnail image are stored in a storage of a server, the thumbnail image being derived from the original image. A first request from a first remote device is received, the first request including information about the first remote device and an identifier that identifies the original image. The thumbnail image is provided to the first remote device upon determining that the resolution of the first remote device does not match the resolution of the original image, and a first derivative image that is a derivative of the original image is generated, the first derivative image having a resolution that matches the resolution of the first remote device. The first derivative image is provided to the first remote device.

Implementations may include one or more of the following features. A second request from a second remote device is received, the second request including information about the second remote device and an identifier that identifies the original image; it is determined that the resolution of the second remote device does not match the resolution of the original image, and that the second remote device has a resolution that is more similar to the first derivative than the original image or the thumbnail image; the first derivative is provided to the second remote device; a second derivative of the original image is generated, the second derivative having a resolution that matches the resolution of the second remote device; and the second derivative of the original image is provided to the second remote device.

In general, in another aspect, original content items and derivative content items are stored in folders, each folder storing one original content item and one or more derivative content items that are derived from the original content item. Content items are adaptively provided to remote devices, including the following. For each request from a remote device requesting a particular original content item, it is determined whether any content item in the folder associated with the particular original content item has properties that match corresponding properties of the remote device. If none of the content items in the folder associated with the particular original content item has properties that match corresponding properties of the remote device, one of the content items in the storage having properties that more closely match corresponding properties of the remote device is provided, a new derivative content item that is a derivative of the original content item is generated, the new derivative content item having properties that match corresponding properties of the remote device, and the new derivative content item is sent to the remote device.

Implementations may include one or more of the following features. Storing the original content items and derivative content items include storing original images and derivative images in the folders. Determining whether any content item in the folder associated with the particular original content item has properties that match corresponding properties of the remote device includes determining whether any content item in the folder associated with the particular original content item has a pixel resolution that matches a display resolution of the remote device.

In general in another aspect, requests from remote devices requesting multimedia content items are received. New derivative multimedia content items are generated if currently available original multimedia content items and derivative multimedia content items do not match the properties of the remote devices, the new derivative multimedia content items more closely matching the properties of the remote devices than the currently available original and derivative multimedia content items. The original or derivative multimedia content items are adaptively provided to the remote devices by initially providing currently available original or derivative multimedia content items that most closely match the properties of the remote devices, then providing the new derivative multimedia content items as the new derivatives become available.

Implementations may include one or more of the following features. The original and derivative multimedia content items are organized in folders, each folder including one of the original multimedia content items and derivative multimedia content items that are derived from the original multimedia content item. Generating new derivative multimedia content items if currently available original multimedia content items and derivative multimedia content items do not match the properties of the remote devices includes generating new derivative multimedia content items if currently available original multimedia content items and derivative multimedia content items do not match the display resolutions of the remote devices.

In general, in another aspect, a content server is provided to adaptively serve requests from client devices requesting content items. The content server includes a content analyzer and a content processing engine. The content analyzer determines whether the properties of the client devices match corresponding properties of original content items and derivative content items stored in a storage. The content processing engine generates a new derivative content item in response to a request for an original content item from a client device when properties of currently available original and derivative content items do not match the properties of the client device the new derivative content item having properties that more closely match the corresponding properties of the client device than the currently available original and derivative content items.

Implementations may include one or more of the following features. The content server, in response to the request for the client device, provides a currently available content item to the client device, and subsequently provides the new derivative content item to the client device. A storage including folders is provided, each folder storing an original content item and one or more derivative content items that are derived from the original content item. A device analyzer is provided to determine properties of the client devices.

In general, in another aspect, means for receiving requests from remote devices requesting multimedia content items is provided. Means for generating new derivative multimedia content items if currently available original multimedia content items and derivative multimedia content items do not match the properties of the remote devices is provided, the new derivative multimedia content items more closely matching the properties of the remote devices than the currently available original and derivative multimedia content items. Also provided is means for adaptively providing the original or derivative multimedia content items to the remote devices by initially providing currently available original or derivative multimedia content items that most closely match the properties of the remote devices, then providing the new derivative multimedia content items as the new derivatives become available.

Implementations may include one or more of the following features. Means for organizing the original and derivative multimedia content items in folders is provided, each folder including one of the original multimedia content items and derivative multimedia content items that are derived from the original multimedia content item.

These and other aspects and features, and combinations of them, may be expressed as methods, apparatus, systems, means for performing functions, program products, and in other ways. These and other aspects and features, and combinations of them, may have one or more of the following advantages. Derivative content items are adaptively generated when needed, allowing efficient use of a storage device for storing the original and derivative content items. By sending lower-quality content (e.g., lower-resolution images) first and subsequently sending higher-quality content (e.g., images having resolutions that better match the display resolutions of the client device), a good balance can be achieved between content quality and content delivery speed.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows a schematic diagram of an example content server for publishing content adaptively.

FIG. 2 is a signal flow diagram showing an exchange of signals between a client device and the content server.

FIGS. 3-5 are diagrams of derivative folders storing original and derivative content items.

FIGS. 6-8 are flow diagrams of processes.

Like reference numbers and designations in the various drawings indicate like elements.

### DETAILED DESCRIPTION

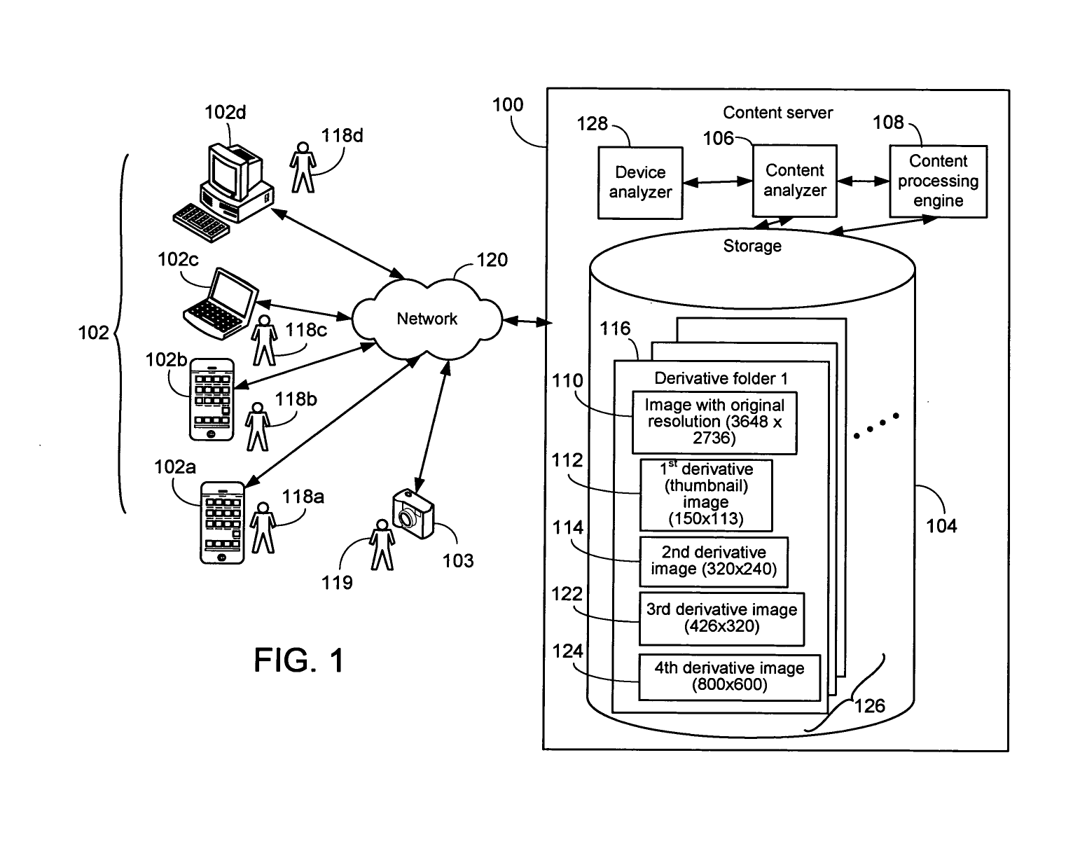

Referring to FIG. 1, a content server 100 provides content (e.g., multimedia content, such as images, audio, video) to client devices 102. The client devices 102 can be, for example, mobile phones 102a and 102b, laptop computers 102c, or desktop computers 102d. The content server 100 includes a storage 104 for storing content items, which may include original content items (e.g., 110) and derivative content items (e.g., 112. 114, 122, 124). For example, an original content item may be a high-resolution digital image downloaded from a digital camera (e.g., 103), and a derivative content item may be a low-resolution image down-sized from the original high-resolution image.

When a user 118 uses a client device 102 to send a request to the content server 100 to request a content item (e.g., a particular digital photo), the request may include information (e.g., make and model) about the client device 102. The content server 100 determines properties (e.g., display resolution) of the client device 102 based on the information, and sends the client device 102 a content item that satisfies the request and has properties that match those of the client device 102, if such content item is available. If none of the currently available content items satisfying the request has properties that match those of the client device 102, the content server 100 sends the client device 102 a currently available content item that satisfies the request and has properties that most closely match those of the client device 102. The content server 100 then generates a derivative content item having properties that match those of the client device 102, and sends the derivative content item to the client device 102. The new derivative content item is stored for future use.

A feature of the content server 100 is that it allows users (e.g., 119) to upload content items to the content server 100 in whatever format available to the users, and allows users (e.g., 118) to download content items using various client devices 102. The device client devices 102 may have properties (e.g., display resolutions) that do not match those of the content items. The content server 100 allows users 118 of the client devices 102 to quickly receive content items regardless of whether the content items have properties that match those of the client devices 102. If an initial content item sent to a client device 102 has a property that does not match a corresponding property of the client device 102, the initial content item is replaced by a derivative content item having properties that match those of the client device 102 in a short period of time. Content items having properties that match those of client devices 102 are generated on-demand, allowing more efficient use of the storage 104.

In the examples described herein, when a user 118 requests an original image file, for example, by sending an HTTP request that includes a universal resource locator (URL) of an image file “Golden Gate Bridge.jpg” stored at the content server 100, the user 118 is not necessarily requesting the exact file “Golden Gate Bridge.jpg”. What the user 118 wishes to see is the image represented by the “Golden Gate Bridge.jpg” file, so the request can be satisfied by sending the user 118 a derivative image file (e.g., “Golden Gate Bridge Thumbnail.jpg”) that shows an image resized from the original image.

Similarly, when the user 118 requests an original video file, the request can be satisfied by sending a derivative video file having a different resolution or encoding scheme than the original video file while maintaining similar content (e.g., the same movie). When the user 118 requests an original audio file, the request can be satisfied by sending a derivative audio file having a different bit rate or encoding scheme than the original audio file while maintaining similar content (e.g., the same song).

### EXAMPLE 1

The following describes an example in which the content items are digital images of an on-line photo album 126. A user 119 who uploads the images to the photo album 126 is referred to as a “producer” 119, and a user 118 who downloads and views the images is referred to as a “viewer” 118. A person can be both a producer 119 and a viewer 118.

The content server 100 allows a producer 119 to organize the photos in a user-friendly way, e.g., by using nested directories. For example, one directory may include photos taken on a certain day, and another directory may include photos taken during a vacation. The content server 100 also organizes the content items using “derivative folders” 116, in which each original content item and its associated derivative content items are stored in an individual derivative folder 116. For example, if the producer 119 uploads one hundred different photos 110 to the photo album 126, the content server 100 establishes one hundred derivative folders 116, each derivative folder 116 being associated with one photo 110. The derivative folders 116 are mainly used by the content server 100 for organizing the original and derivative content items, and may be “hidden” from the users 118 and 119.

When images 110 are up loaded to the online photo album 126, the content server 100 automatically generates a thumbnail image 112 for each uploaded image 110. For example, the thumbnail image 112 can have about 150 pixels on the long side. The image 110 that is uploaded by the producer 119 is referred to as an “original” image 110, and the thumbnail image 112 is referred to as a “derivative” image 112 because the thumbnail image 112 is derived from the original image 110. Each original image 110 and its associated thumbnail image 112 are stored in a derivative folder 116 associated with the original image 110.

The content server 100 may generate two or more thumbnail images 112 of various sizes for each original image for use in different applications. For example, smaller thumbnail images can be used for showing on smaller displays of mobile phones, and larger thumbnail images can be used for showing on larger displays of desktop computers.

As an example, a viewer 118a wishes to use a mobile phone 102a to view a photo 110 in full screen mode. The photo 110 has a pixel resolution of 3648×2736 pixels (i.e., horizontal 3648 pixels and vertical 2736 pixels). Assume that the mobile phone 102a has a display having a resolution of 320×480 pixels. The mobile phone 102a sends an HTTP request to the content server 100 to request the photo 110. The HTTP request includes a user-agent field (e.g., a text string) having information about the make and model of the mobile phone 102a. In this example, the mobile phone 102a includes a motion sensor that senses the orientation of the display, and the user-agent field includes information about the orientation of the mobile phone display.

The content server 100 includes a device analyzer 128 that analyzes the user-agent information to determine properties of the mobile phone 102a. For example, the device analyzer 128 may access a database (not shown) having information about the properties of various devices. The device analyzer 128 determines that the mobile phone 120a has a display operating in a portrait mode with a resolution of 320×480 pixels. The content server 100 includes a content analyzer 106 that analyzes the content items in the derivative folder 116 associated with the requested image 110 to determine whether there is a content item that satisfies the request and has properties that match those of the mobile phone 102a.

In this example, the content analyzer 106 determines that neither the original image 110 (3648×2736 pixels) nor the thumbnail image 112 (150×113 pixels) has a resolution that matches the resolution of the mobile phone display (320×480 pixels). The content analyzer 106 determines that the display resolution (320×480 pixels) is closer to the resolution of the thumbnail image 112 (150×113 pixels), so the content server 100 serves the thumbnail image 112 to the mobile phone 102a. When the mobile phone 102a receives the thumbnail image 112, an image viewer program enlarges the thumbnail image 112 to a resolution of 320×240 pixels and shows the enlarged image on the display. This assumes that the image is shown on the mobile phone 102a in full-screen mode. The image viewer program may resize the image to other sizes.

The content analyzer 106 queries a content processing engine 108 and requests the engine 108 to generate a derivative image having a resolution of 320×240 pixels from the original image 110 (3648×2736 pixels). In response, the content processing engine 108 processes the original image 110 to generate a second derivative image 114 having a resolution of 320×240 pixels (the thumbnail image 112 being the first derivative image), and stores the second derivative image 114 in the derivative folder 116. The second derivative image 114 derived from the original image 110 can show finer details than an enlarged image derived from the thumbnail image 112.

The content server 100 sends the second derivative image 114 to the mobile phone 102a, which replaces the enlarged thumbnail image with the second derivative image 114. Because the second derivative image 114 has a resolution that matches the display resolution of the mobile phone 102a (in this case, meaning that the horizontal resolution of the derivative image 114 matches the horizontal resolution of the mobile phone display operating in the portrait mode), the image quality is improved.

When the viewer 118a requests the image 110, an initial image (in this case, an enlarged thumbnail image 112) appears on the mobile phone display relatively quickly. The thumbnail image 112 has a small file size and can be transmitted from the content server 100 to the mobile phone 102a quickly. Although the initial image may be a bit unclear or fuzzy, the image quality improves shortly thereafter when the mobile phone 102a receives the second derivative image 114. The second derivative image 114 is sent to the mobile phone 102a and shown to the viewer 118a without further instruction from the viewer 118a.

When the viewer 118a rotates the mobile phone display 90 degrees so that the display is operating in a landscape mode, the image viewing program automatically resizes the 320×240 image to a 426×320 image so as to match the vertical resolution of the display (or to a 480×320 image, with a portion of the original image cropped, to match the vertical and horizontal resolutions of the display).

The mobile phone 102a sends a message to the content server 100 indicating that the mobile phone display is now operating in the landscape mode. The device analyzer 128 determines that the mobile phone display operating in the landscape mode has a resolution of 480×320 pixels. The content analyzer 106 searches the derivative folder 116 to determine whether any of the images stored in the derivative folder 116 has a resolution that matches the resolution of the display. In this case, the content analyzer 106 determines that none of the images in the derivative folder 116 has a resolution that matches the resolution of the display in the landscape mode.

The content analyzer 106 queries the content processing engine 108 to down-size the original 3648×2736 image 110 to a resolution of 426×320 pixels. In response, the engine 108 process the original 3648×2736 image 110 to generate a third derivative image 122 having a resolution of 426×320 pixels, and stores the third derivative image 122 in the derivative folder 116. The content sever 100 sends the third derivative image 122 to the mobile phone 102a, which replaces the enlarged second derivative image 114 with the third derivative image 122.

When a second viewer 118b uses a second mobile phone 102b, also having a display resolution of 320×480 pixels, to view the image 110, the derivative images 114 and 122 in the derivative folder 116 can be re-used. The content server 100 sends the second derivative image 114 (320×240 pixels) to the mobile phone 102b if the display of the mobile phone 102b is operating in the portrait mode. On the other hand, the content server 100 sends the third derivative image 122 (426×320 pixels) to the mobile phone 102b if the display of the mobile phone 102b is operating in the landscape mode.

Suppose, a third viewer 118c uses a laptop computer 102c having a display resolution of 800×600 pixels to browse the photo album 126 and decides to view the 3748×2736 image 110 in full screen mode. The device analyzer 128 determines that the request is from a laptop computer having a display resolution of 800×600 pixels. The content analyzer 106 determines that, among the images in the derivative folder 116 associated with the image 110, the third derivative image 122 having a resolution of 426×320 pixels is closest to the laptop display resolution. The content server 100 sends the third derivative image 122 to the laptop computer 102c, and an image viewer program residing at the laptop computer 102c enlarges the image 122 to a resolution of 800×600 pixels.

The content analyzer 106 queries the content processing engine 108 to down-size the original 3648×2736 image 110 to a resolution of 800×600 pixels. In response, the content processing engine 108 process the original image 110 to generate a fourth reduced-size derivative image 124 having a resolution of 800×600 pixels and stores the fourth derivative image 124 in the derivative folder 116. The content server 100 sends the fourth derivative image 124 to the laptop computer 102c, which shows the third derivative image 124 on the display, replacing the enlarged second derivative image 114.

As the above example shows, generating derivative images when needed allows efficient use of the storage device 104. Some original images (e.g., 110) in the storage 104 may be requested by only a few different types of client devices 102, so only a few derivative images are generated. Some original images may be requested by many different types of client devices 102, so that many derivative images are generated. In the example above, the content server 100, other than generating a thumbnail image 112, does not generate additional derivative images until requests from client devices 102 are received. The derivative images are adaptively generated at the time that they are needed. This allows more efficient use of the storage 104, as compared to generating several derivative images in anticipation of requests from various types of client devices 102 before the requests are received.

The content server 100 may specify criteria for the generation and storage of the derivative images. For example, the content server 100 may specify that the difference between the client device display resolution and the resolution of the closest derivative image should be more than a preset amount (e.g., the difference in pixel numbers should be more than 20%) before a new derivative image is generated. The content server 100 may set an upper limit on the total file sizes of the original images 110 and the derivative images belonging to a user. The content server 100 may limit the total file size of the derivative images in any derivative folder 116, and less commonly used derivative images can be deleted to provide space for new derivative images when the limit is exceeded.

When an original image is modified, the corresponding derivative images are marked as invalid, and new derivative images are generated based on the updated original image. The content server 100 includes built-in logic that compares the creation date of an original file (e.g., 110) and the creation date of the derivative files (e.g., 112, 114, 122, 124). If the creation date of the original file is more recent than the derivative files, it indicates a possibility that the original file has changed, so the derivative files are marked as invalid. New derivative files are generated upon receiving requests from the client devices 102. This way, when a content owner re-publishes an original image (e.g., after cropping the image or re-touching the image), the corresponding derivative images served to client devices 102 will be based on the updated original image, rather than the old derivative images.

The method of sending an available content item and later improving the quality of the content item if possible (for example, sending an initial image having a lower resolution followed by a derivative image having a higher resolution) is referred to as “trickle publishing”, meaning that content is published in trickles as newer versions of the content become available over time. In trickle publishing, whatever content item available is first published, followed by a content item that has a higher quality or has properties that match corresponding properties of the device requesting the content item.

Trickle publishing provides a good user experience by providing the user a quick initial response and high quality content over time. For example, while the content server 100 can send the original high resolution image 110 to the mobile phone 102a, because of the large file size, it may take a long time for the image 110 to be transmitted to the mobile phone 102a. The original image 110 may also take up significant memory and computation resources of the mobile phone 102a. Sending only the thumbnail image 112 allows the image to appear on the mobile phone display quickly, but the enlarged thumbnail image may not be clear. By comparison, trickle publishing provides a better balance between the content delivery speed and the quality of the content.

For example, suppose that the publisher 119 has uploaded the photos to the photo album 126, and the content server 100 has generated thumbnail images for the photos. A viewer 118 use a client device 102 to request a slideshow of the photos in the photo album 126. When the content server 100 receives the request for a slideshow, the content server 100 sends a thumbnail image of the first photo to the client device 102, followed by a derivative image of the first photo that matches the resolution of the client device display. The slideshow may be configured to have a pause (e.g., a 3-second pause) between photos. During the pause between showing the first photo and showing the second photo, the content server 100 generates and sends a derivative image of the second photo to the mobile phone 102a. Thus, the client device 102 can show a derivative image of the second photo without showing a thumbnail image of the second photo. Similarly, during the pause between showing the second photo and showing the third photo, the content server 100 generates and sends a derivative image of the third photo to the mobile phone 102a, and so forth.

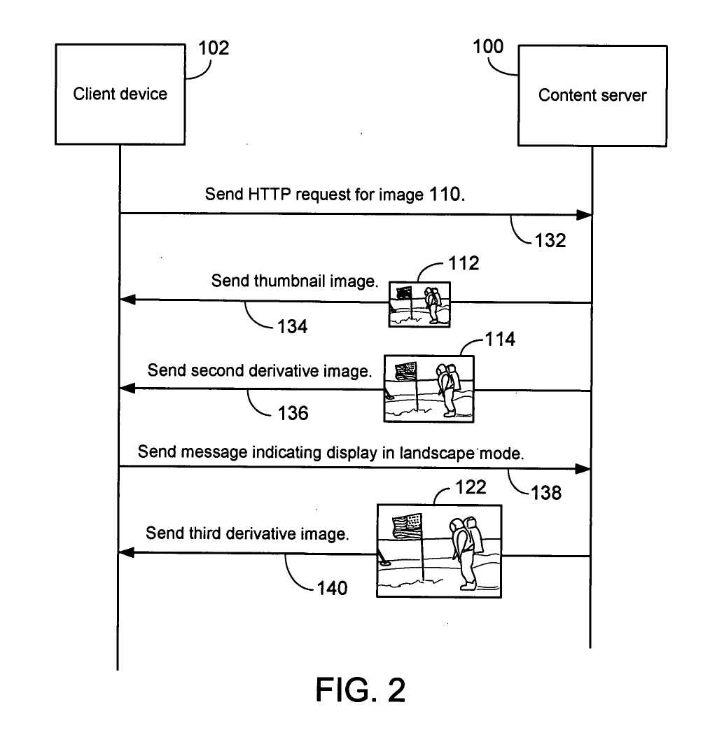

FIG. 2 is a signal flow diagram showing the exchange of signals between a client device 102 and the content server 100 when the client device 102 requests a content item. The client device 102 sends an HTTP request to the content server 100 (132). The HTTP request includes information about the display properties of the client device 102 and identifies the image 110. The HTTP request also indicates that the client device display is operating in a portrait mode. The content server 100 sends a thumbnail image 112 to the client device (134). Shortly thereafter, the content server 100 sends a second derivative image 114 to the client device 102 (136). The second derivative image has a pixel resolution that matches the resolution of the client device display operating in the portrait mode. The client device 102 sends a message to the content server 100 indicating that the display is operating in a landscape mode (138). The content server 100 sends a third derivative image to the client device 102 (140). The third derivative image has a pixel resolution that matches the resolution of the client device display operating in the landscape mode.

### EXAMPLE 2

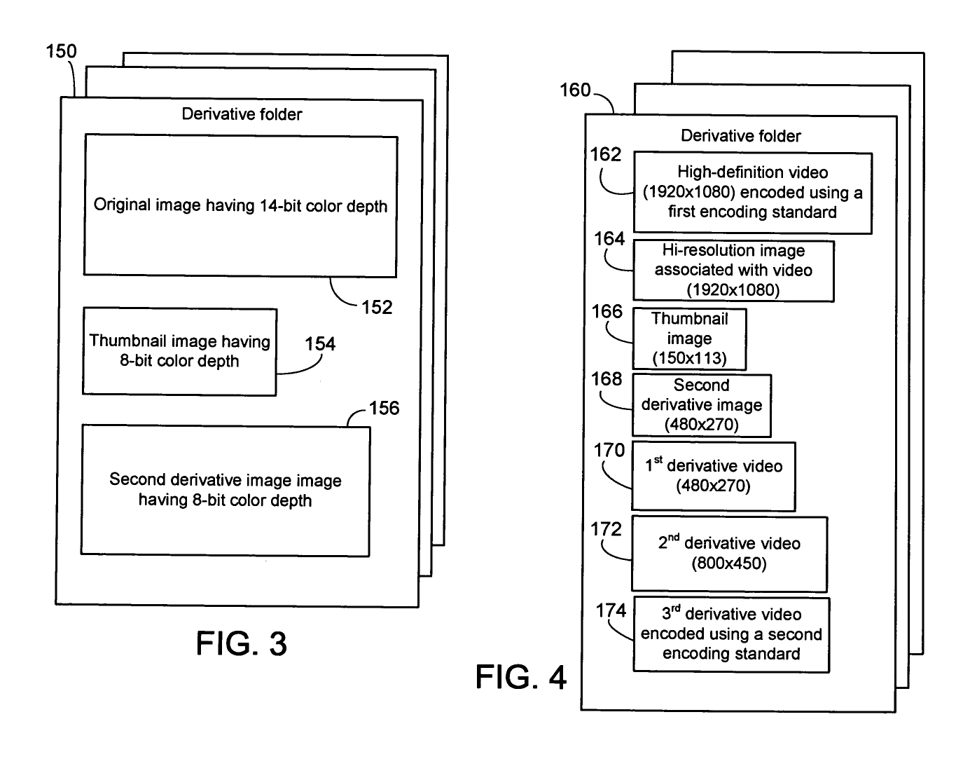

Referring to FIG. 3, trickle publishing can be used to publish images having different spectral resolutions. For example, a derivative folder 150 may store an original color image 152 in which each pixel of the image 152 is represented by 14 bits, allowing 2¹⁴ gray scale levels for each pixel. The derivative folder 150 may also store a thumbnail image 154 in which each pixel of the thumbnail image 154 is represented by 8 bits. The remote device 102, such as a mobile phone 102a, may be configured to process color images in which each pixel is represented by 8 bits. The content server 100, upon receiving a request from the mobile phone 102a, first sends the thumbnail image 154 to the mobile phone 102a. The content sever 100 generates a second derivative image 156 having a pixel resolution and spectral resolution matching that of the mobile phone 102a, in which each pixel of the second derivative image 156 is represented by 8 bits. The content server 100 sends the second derivative image 156 to the mobile phone, which replaces the thumbnail image 154 with the second derivative image 156.

### EXAMPLE 3

Referring to FIG. 4, trickle publishing can be applied to publishing of videos. For example, a derivative folder 160 may store a high-definition video 162 available to subscribers. The high-definition video 162 may have a resolution of 1920×1080 pixels. An owner of the high-definition video 162 may provide the content server 100 an image 164 to be shown prior to playing the video 162. For example, the image 164 can have a resolution of 1920×1080 pixels. The image 164 can be an image of a movie poster that shows the title and main characters of the movie. The content server 100 generates a thumbnail image 166 derived from the original image 164.

In one example, a viewer 118d accesses the video 162 using a video player program executing on a personal computer 102d that is capable of playing the high-definition video 162. When the content server 100 streams the high definition video 162 to the client device 102, it may take a short period of time before the video player actually starts showing the video 162 to the viewer 118. For example, the video player may require data for a number of video frames to be buffered before proper decoding begins. Rather than letting the viewer 118 see a blank screen while waiting for the video to start, the content server 100 can send the high-definition image 164 to the client device 102 first so that the viewer 188 can see content (in this case, a still image 164) relevant to the video 162 while waiting for the video 162 to start.

In one example, a viewer 118a uses a mobile phone 102a to access the high-definition video 162. The content server 100 determines that the resolution of the mobile phone 102a in landscape mode is 480×320 pixels, which is much lower than the resolution of the high definition video 162. The content server 100 sends the thumbnail image 166 to the mobile phone 102a, then generates and sends a second derivative image 168 that is derived from the high-definition image 164 to the mobile phone 102a. The second derivative image 168 has a resolution that matches the display resolution of the mobile phone 102a.

The content server 100 generates a low-definition derivative video 170 that is derived from the high-definition video 162. The low-definition derivative video 170 has a resolution of 480×270, which matches the long-side of the display of the mobile phone 102a. After a certain amount of low-definition derivative 170 to the mobile phone 102a, while continuing to generating the remaining portion of the low-definition video 170. The low-definition derivative 170 has a resolution that matches the resolution of the mobile phone display 102a. Prior to receiving the low-definition derivative video 170, the viewer 118a sees an enlarged thumbnail image 166 and subsequently the second derivative image 168. This provides a better user experience than showing a bland screen while the user 118a waits for the low-definition derivative video 170 to be shown.

In one example, a user 118c uses a client device 102c (e.g., a laptop computer) that has a 800×600 display resolution and connects to the content server 100 using a low-bandwidth connection. When the client device 102c sends a request to the content server 100 to access the video 162, the client device 102c also sends information about the low-bandwidth connection to the content server 100. The device analyzer 128 determines that a better user experience can be provided by streaming a 800×600 resolution video through the low-bandwidth connection than streaming the 1920×1080 high-definition video 162.

The content analyzer 106 searches the derivative folder 160 and determines that the derivative folder 160 does not have a version of the video 162 with a 800×600 resolution, but has a low-definition derivative video 170 having a 480×270 resolution. The content server 100 streams the low-definition derivative video 170 to the client device 102c. The content processing engine 108 also processes the high definition video 162 to generate a low-definition derivative video 172 having a 800×450 resolution. The next time the client device 102c or another client device 102 having a display resolution 800×600 requests the video 162, the content server 100 streams the derivative video 172.

In one example, the original video 162 is encoded using a first video encoding standard, such as H.264. A client device 102 may not be capable of decoding the original video 160, but is capable of decoding videos encoded using a second video encoding standard, such as MPEG-2. When a user 118 uses the client device 102 to access the original video 162, the device analyzer 128 determines that the client device 102 is not capable of decoding the original video 162, but is capable of decoding a video encoded according to the second video standard. The content analyzer 106 determines that the derivative folder 160 does not have a derivative video encoded according to the second video standard.

The content analyzer 106 queries the content processing engine 108 to generate a derivative video that can be decoded by the client device 102. The content processing engine 108 generates a third derivative video 174 by trans-coding the original video 162 according to the second video encoding standard. Rather than letting the client device 102 show a blank screen while waiting for the content processing engine 108 to convert the video, the content server 100 sends the client device 102 the thumbnail image 166, then a derivative image (e.g., 168) that matches the resolution of the display of the client device 102. When the content processing engine 108 has processed a certain portion of the video, the content server 100 starts streaming the third derivative video 174 to the client device 102, while continuing to convert the remaining portion of the video.

### EXAMPLE 4

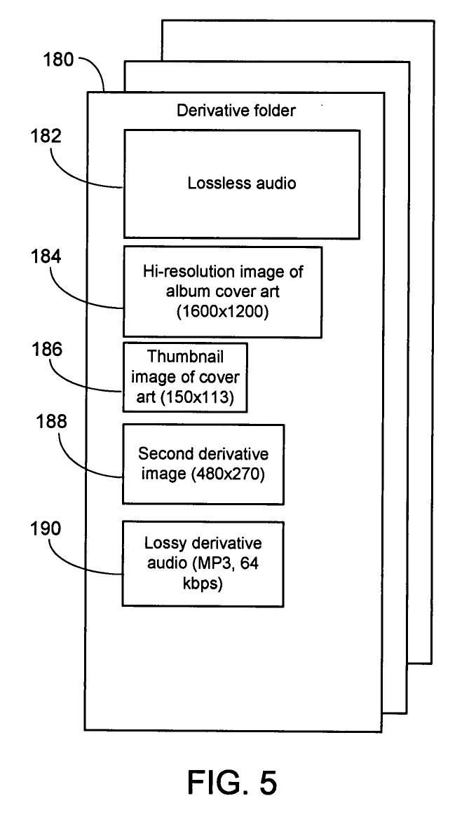

Referring to FIG. 5, trickle publishing can be applied to publishing of audio content. For example, the derivative folder 180 can store an audio file 182 encoded using a lossless encoding algorithm. The owner of the audio file 182 may provide the content server 100 an image 184 to be shown when playing the audio file 182. For example, the image 184 can be a high-resolution (e.g., 1600×1200 pixels) image of an album cover art. The content server 100 generates a thumbnail image 186 derived from the original image 184.

In one example, upon receiving a request from a client device 102 for accessing the audio file 182, the content server 100 sends the thumbnail image 186 to the client device 102, then generates and sends a derivative image 188 to the client device 102, the derivative image 188 having a resolution that matches the display resolution of the client device 102. The content server 100 streams the audio 182 to the client device 102. This way, the user 118 sees an image associated with the audio 182 quickly after requesting for the audio 182, and shortly thereafter the audio 182 starts to play on the client device 102.

In one example, a user 118a uses a mobile phone 102a to access the audio file 182. The mobile phone 102a is not capable of playing the lossless encoded audio file 182, but is capable of playing MP3 audio having a bit rate up to 64 kbits per second. The content server 100 sends the thumbnail image 186 to the mobile phone 102a, then sends a derivative image 188 that matches the display resolution of the mobile phone 102a. The content processing engine 108 generates a derivative audio file 190 by converting the lossless audio file 182 to a 64 kbps MP3 file. The content server 100 streams the derivative audio file 190 to the mobile phone 102a. This way, the user 118c can see a cover art image quickly after requesting the audio file 180, and shortly thereafter receives the derivative audio file 190 that can be played on the mobile phone 102a.

In some examples, when the client device 102 sends a request to the content server 100 to request a content item, the request may not provide the specific make and model of the client device 102. The request may specify the category of the client device 102, such as indicating that the client device 102 is a desktop computer, a laptop computer, or a mobile phone. In this case, the content analyzer 106 looks up a table having information about typical capabilities (e.g., display resolutions, audio or video decoding capabilities) of different categories of devices to determine the capability of the client device 102.

### Processes for Adaptive Publishing of Content

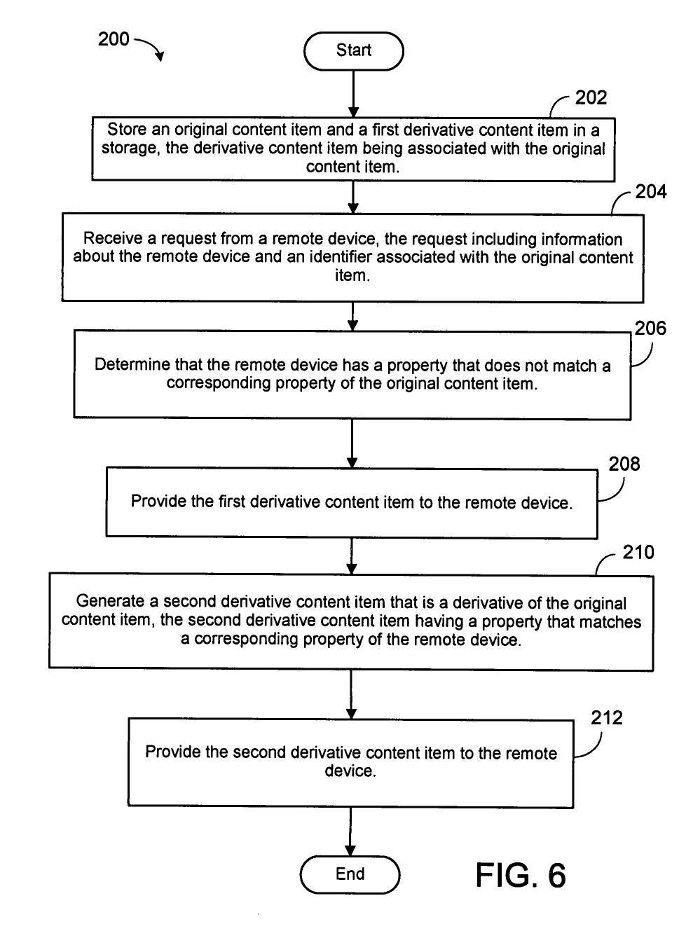

FIG. 6 shows an example process 200 for adaptive publishing of content. The process 200 includes storing an original content item and a first derivative content item in a storage, the derivative content item being associated with the original content item (202). For example, the process 200 can be implemented by the content server 100 (FIG. 1), the original content item can be the original image 110, and derivative content item can be the thumbnail image 112.

The process 200 includes receiving a request from a remote device, the request including information about the remote device and an identifier associated with the original content item (204). For example, the remote device can be the client device 102, the request can be an HTTP request that includes a user-agent field having information about the make and model of the client device 102.

The process 200 includes determining that the remote device has a property that does not match a corresponding property of the original content item (206). For example, the property of the remote device can be the display resolution of the client device 102, and the corresponding property of the original content item can be the pixel resolution of the original image 110.

The process 200 includes providing the first derivative content item to the remote device (208). The process 200 includes generating a second derivative content item that is a derivative of the original content item, the second derivative content item having a property that matches a corresponding property of the remote device (210). The process 200 includes providing the second derivative content item to the remote device (212). For example, the second derivative content item can be the second derivative image 114.

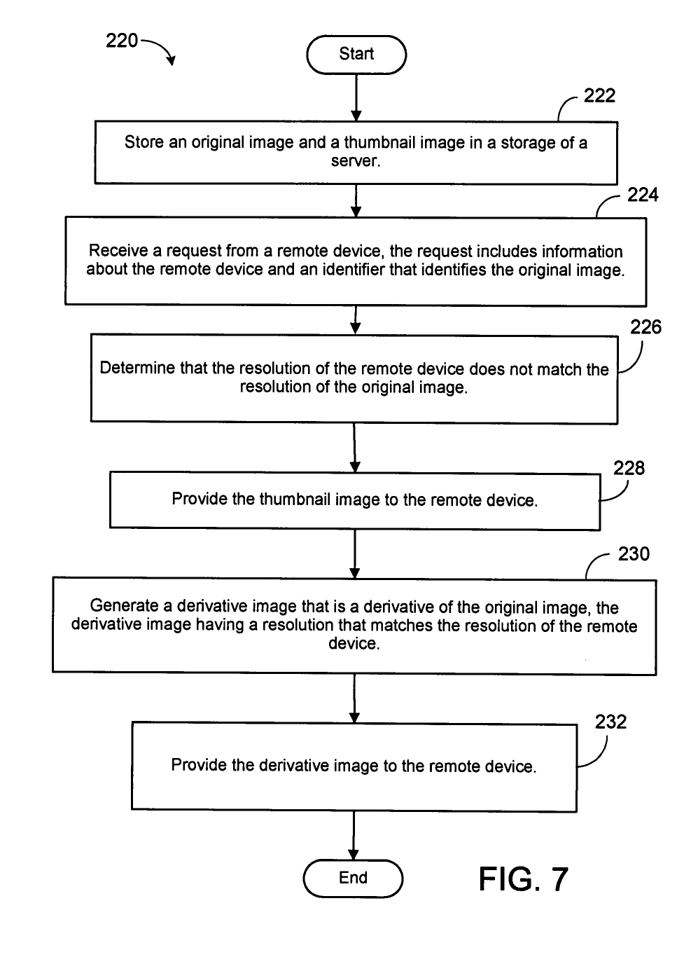

FIG. 7 shows an example process 220 for adaptive publishing of images. The process 220 includes storing an original image and a thumbnail image in a storage of a server, the thumbnail image being derived from the original image (222). For example, the process 220 can be implemented by the content server 100 (FIG. 1), the original image can be the original image 110, and thumbnail image can be the thumbnail image 102.

The process 220 includes receiving a request from a remote device, the request including information about the remote device and an identifier that identifies the original image (224). For example, the remote device can be the client device 102, the request can be an HTTP request that includes a user-agent field having information about the make and model of the client device 102.

The process 220 includes determining that the resolution of the remote device does no match the resolution of the original image (226). The process 220 includes providing the thumbnail image to the remote device (228). The process 220 includes generating a derivative image that is a derivative of the original image, the derivative image having a resolution that matches the resolution of the remote device (230). The process 220 includes providing the derivative image to the remote device (232). For example, the derivative image can be the derivative image 114.

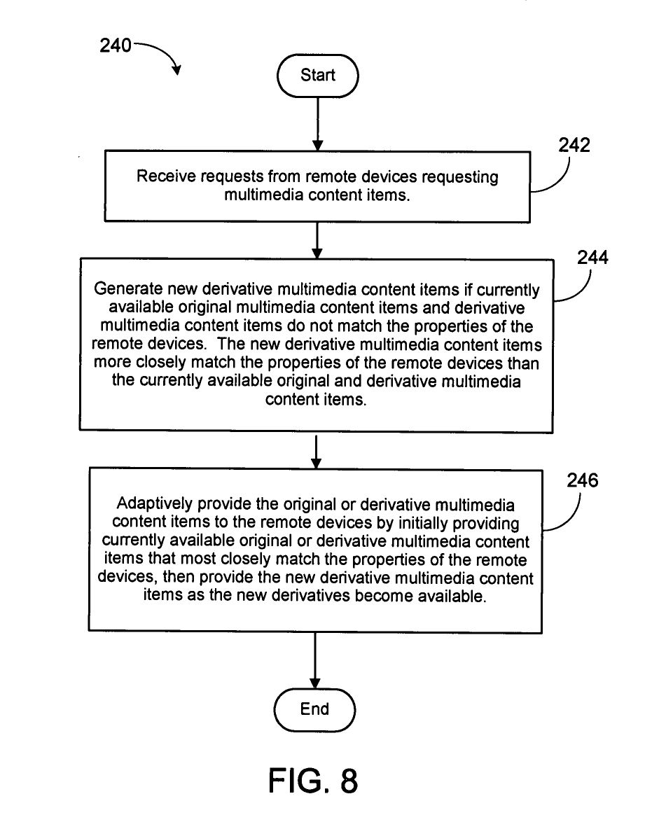

FIG. 8 shows an example process 240 for adaptive publishing of multimedia content. The process 240 includes receiving requests from remote devices requesting multimedia content items (242). For example, the process 240 can be implemented by the content server 100 (FIG. 1), and the remote devices can be the client devices 102. The multimedia content can include images, audio, and video. The requests can be HTTP requests.

The process 240 includes generating new derivative multimedia content items if currently available original multimedia content items and derivative multimedia content items do not match the properties of the remote devices (244). The new derivative multimedia content items more closely match the properties of the remote devices than the currently available original and derivative multimedia content items.

The process 240 includes adaptively providing the original or derivative multimedia content items to the remote devices by initially providing currently available original or derivative multimedia content items that most closely match the properties of the remote devices, then providing the new derivative multimedia content items as the new derivatives become available (246). For example, a lower-resolution image may be provided first, followed by providing an image having a pixel resolution that matches the display resolution of the remote device.

Embodiments of the subject matter and the functional operations described in this specification can be implemented in digital electronic circuitry or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer readable medium. The computer readable medium can be a machine readable storage device, a machine readable storage substrate, a memory device, a composition of matter effecting a machine readable propagated signal, or a combination of one or more of them.

The term “data processing apparatus” encompasses all apparatus, devices, and machines for processing data, including by way of example a programmable processor,a computer, or multiple processors or computers. The apparatus can include, in addition to hardware, code that creates an execution environment for the computer program in question, for example, code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (for example, one or more scripts stored in a markup language document), in a single file dedicated to the program in question, or in multiple coordinated files (for example, files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, for example, an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, for example, magnetic, magneto optical disks, or optical disks. However, a computer need not have such devices.

Computer readable media suitable for storing computer program instructions and data include all forms of non volatile memory, media and memory devices, including by way of example semiconductor memory devices, for example, EPROM, EEPROM, and flash memory devices; magnetic disks, for example, internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, for example, a CRT (cathode ray tube) or a flat panel display, such as a LCD (liquid crystal display) monitor, for displaying information to the user and a keyboard and a pointing device, for example, a mouse or a trackball, by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input.

Embodiments of the subject matter described in this specification can be implemented in a computing system that includes a back end component, for example, as a data server, or that includes a middleware component, for example, an application server, or that includes a front end component, for example, a client computer having a graphical user interface or a Web browser through which a user can interact with an implementation of the subject matter described is this specification, or any combination of one or more such back end, middleware, or front end components. The components of the system can be interconnected by any form or medium of digital data communication, for example, a communication network. Examples of communication networks include a local area network (“LAN”) and a wide area network (“WAN”), for example, the Internet.

The computing system can include clients and servers. A client and server are generally remote from each other and typically interact through a communication network. The relationship of client and server arises by virtue of computer programs running on the respective computers and having a client server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

For example, the client devices 102 can be different from those described above. The network 120 can be any type of network, such as a private network, an intranet, or Internet. The modules (such as the content analyzer 106 and the content processing engine 108 in FIG. 1) can be implemented in software or hardware. The requests from the client device 102 to the content server 100 can be different from HTTP requests. A derivative content item does not have to be generated directly from an original content item. For example, a second derivative image can be resized from a first derivative image, and in which the first and second derivative images are both derivatives of an original image.

When the content server generates and sends derivative content items to the client devices, the derivative content items do not necessarily have properties that exactly match those of the client devices. For example, a derivative image may be slightly smaller or larger than the display resolution of the client device. An image viewer program residing on the client device can resize the derivative image without noticeable loss of image quality.

In generating a derivative image, the content server 100 may perform advanced processing in addition to resizing the original image upon request from the client device 102. For example, suppose a photo album includes photos of a wedding, including an original 3648×2736 image showing a newlywed couple in front of a church. The faces of the bride and groom may occupy less than one-tenth of the original image. Suppose the client device 102 has a display resolution of 480×320. If the image is resized to 426×320, the faces of the bride and groom may be small and difficult to recognize. The client device 102 may send a signal to the content server 100 requesting that images of the photo album be shown with an emphasis on faces. The content server 100 may use face-detection algorithms to recognize faces in images, and generate derivative images with faces enlarged. For example, the content server 100 may generate and send the client device 102 a 426×320 derivative image in which the faces of the bride and groom occupy one-third the height of the image. Similarly, upon request from the client device, the content server 100 may perform other functions, such as red-eye reduction, when generating derivative images.

In example 3 above, when the client device 102c having a display resolution 800×600 requests a video 162 having a resolution 1920×1080, the content server 100 may stream a low-resolution video 168 having a resolution 480×270 to the client device 102c and generate a derivative video 172 having a resolution 800×450 that can be used the next time that a client device 102 having a similar display resolution requests the video 162. In an alternative example, as the content server 100 streams the low-resolution video 170 to the client device 102c, the content server 100 also generates the derivative video 172. After a certain portion of the derivative video 172 has been generated, the content server 100 sends a request to the client device 102c to indicate that a video file having a better resolution is available, and the client device 102c sends a signal to the content server 100 to request the new derivative video 172. The content server 100 switches to streaming the derivative video 172 to the client device 102c, while continuing to generate the remaining portion of the derivative video 172. The content server 100 may analyze the content of the video being streamed and determines a time point for switching from the 480×270 derivative video 170 to the 800×450 derivative video 172 in a way that causes a minimal disruption to the continuity of the video. For example, the switch may occur at a video break point where there is a change of scene or where there is a black frame. The content server 100 and the client device 102c may exchange information in order to synchronize the switching, from the derivative video 170 to the derivative video 172.

In example 1, the content server 100 invalidates corresponding derivative images when an original image is revised. Similarly, when an original audio or video file (or any other type of original content) is modified, the corresponding derivative files are marked as invalid, and new derivative files are generated upon receiving user requests. If the creation date of the original audio or video file is more recent than the derivative files, it indicates a possibility that the original file has changed, so the derivative files are marked as invalid. Subsequent derivative files that are served to the client device arc based on the updated original file.

Trickle publishing of images can be used in publishing documents, such as web pages, that include images. For example, a web server may host a web page having high-resolution resolution images embedded alongside text. The web page may originally be designed to be shown on a large-size display. Assume that a user 118 uses a notebook computer to read the web page. The notebook computer sends an HTTP request to the web server to request the web page. The web server determines that the notebook computer has a display resolution lower than those of the high-resolution images. The web sever sends the HTML code for the web page and low-resolution thumbnail images to become embedded in the web page to the notebook computer. The web server generates derivative images having resolutions that match the display resolution of the notebook computer. The web server sends a signal to the notebook computer indicating that the previously sent images are not optimal and updated images with better resolutions are available. The notebook computer sends another request to the web sever for the web page, and the web server responds by sending the HTML code for the web page and images with resolutions that match the notebook computer's display resolution. This allows the web server to provide better user experiences for different users using various client devices having various display resolutions.

What is claimed is:

1. A computer-implemented method, comprising:
storing an original content item and a first derivative content item in a storage, the derivative content item being associated with the original content item;
receiving a request from a remote device, the request including information about the remote device and an identifier associated with the original content item;
determining that the remote device has a property that does not match a corresponding property of the original content item;
providing the first derivative content item to the remote device;
generating a second derivative content item that is a derivative of the original content item, the second derivative content item having a property that matches a corresponding property of the remote device; and
providing the second derivative content item to the remote device.

2. The method of claim 1 wherein storing the first content item and the first derivative content item comprises storing a first image and a thumbnail version of the first image in the storage.

3. The method of claim 1 wherein storing the first content item and the first derivative content item comprise storing a video file and an image associated with the video in the storage.

4. The method of claim 1 wherein storing the first content item and the first derivative content item comprises storing an audio file and an image associated with the audio file in the storage.

5. The method of claim 1 wherein determining that the remote device has a property that does not match a corresponding property of the original content item comprises determining that the remote device has a display resolution that does not match a pixel resolution of the original content item.

6. The method of claim 5 wherein generating a second derivative content item comprises generating a second derivative content item that has a pixel resolution that matches the display resolution of the remote device.

7. The method of claim 1 wherein determining that the remote device has a property that does not match a corresponding property of the original content item comprises determining that the remote device has a spectral resolution that does not match a spectral resolution of the original content item.

8. The method of claim 7 wherein generating a second derivative content item comprises generating a second derivative content item that has a spectral resolution that matches the spectral resolution of the remote device.

9. The method of claim 1 wherein determining that the remote device has a property that does not match a corresponding property of the original content item comprises determining that the original content item is encoded according to a first encoding algorithm and the remote device is not capable of decoding the encoded original content item.

10. The method of claim 9 wherein generating a second derivative content item comprises generating a second derivative content item that is encoded according to a second encoding algorithm that can be decoded by the remote device.

11. The method of claim 1 wherein receiving a request from a remote device comprises receiving an HTTP request from the remote device.

12. The method of claim 1, further comprising invalidating the derivative content items when the original content item is modified.

13. The method of claim 1, further comprising invalidating the derivative content items when a creation date of the original content item is more recent than the creation date of the derivative content items.

14. A computer-implemented method, comprising:
storing an original image and a thumbnail image in a storage of a server, the thumbnail image being derived from the original image;
receiving a first request from a first remote device, the first request including information about the first remote device and an identifier that identifies the original image;
determining that the resolution of the first remote device does not match the resolution of the original image;
providing the thumbnail image to the fist remote device;
generating a first derivative image that is a derivative of the original image, the first derivative image having a resolution that matches the resolution of the first remote device; and
providing the first derivative image to the first remote device.

15. The method of claim 14 further comprising
receiving a second request from a second remote device, the second request including information about the second remote device and an identifier that identifies the original image;
determining that the resolution of the second remote device does not match the resolution of the original image, and that the second remote device has a resolution that is more similar to the first derivative than the original image or the thumbnail image;
providing the first derivative to the second remote device;
generating a second derivative of the original image, the second derivative having a resolution that matches the resolution of the second remote device; and
providing the second derivative of the original image to the second remote device.

16. A computer-implemented method, comprising:
storing original content items and derivative content items in folders, each folder storing one original content item and one or more derivative content items that are derived from the original content item; and
adaptively providing content items to remote devices, including
for each request from a remote device requesting a particular original content item, determining whether any content item in the folder associated with the particular original content item has properties that match corresponding properties of the remote device, and
if none of the content items in the folder associated with the particular original content item has properties that match corresponding properties of the remote device,
providing one of the content items in the storage having properties that more closely match corresponding properties of the remote device,
generating a new derivative content item that is a derivative of the original content item, the new derivative content item having properties that match corresponding properties of the remote device, and
sending the new derivative content item to the remote device.

17. The method of claim 16 wherein storing the original content items and derivative content items comprise storing original images and derivative images in the folders.

18. The method of claim 16 wherein determining whether any content item in the folder associated with the particular original content item has properties that match corresponding properties of the remote device comprises determining whether any content item in the folder associated with the particular original content item has a pixel resolution that matches a display resolution of the remote device.

19. A computer-implemented method, comprising:
receiving requests from remote devices requesting multimedia content items;
generating new derivative multimedia content items if currently available original multimedia content items and derivative multimedia content items do not match the properties of the remote devices, the new derivative multimedia content items more closely matching the properties of the remote devices than the currently available original and derivative multimedia content items; and
adaptively providing the original or derivative multimedia content items to the remote devices by initially providing currently available original or derivative multimedia content items that most closely match the properties of the remote devices, then providing the new derivative multimedia content items as the new derivatives become available.

20. The methods of claim 19, further comprising organizing the original and derivative multimedia content items in folders, each folder including one of the original multimedia content items and derivative multimedia content items that are derived from the original multimedia content item.

21. The method of claim 19 in which generating new derivative multimedia content items if currently available original multimedia content items and derivative multimedia content items do not match the properties of the remote devices comprises generating new derivative multimedia content items if currently available original multimedia content items and derivative multimedia content items do not match the display resolutions of the remote devices.

22. An apparatus, comprising:
a content server to adaptively serve requests from client devices requesting content items, the content server comprising
a content analyzer to determine whether the properties of the client devices match corresponding properties of original content items and derivative content items stored in a storage; and
a content processing engine to generate a new derivative content item in response to a request for an original content item from a client device when properties of currently available original and derivative content items do not match the properties of the client device, the new derivative content item having properties that more closely match the corresponding properties of the client device than the currently available original and derivative content items.

23. The apparatus of claim 22 wherein the content server, in response to the request for the client device, provides a currently available content item to the client device, and subsequently provides the new derivative content item to the client device.

24. The apparatus of claim 22, further comprising a storage including folders, each folder storing an original content item and one or more derivative content items that are derived from the original content item.

25. The apparatus of claim 22, further comprising a device analyzer to determine properties of the client devices.

26. A system, comprising;
means for receiving requests from remote devices requesting multimedia content items;
means for generating new derivative multimedia content items if currently available original multimedia content items and derivative multimedia content items do not match the properties of the remote devices, the new derivative multimedia content items more closely matching the properties of the remote devices than the currently available original and derivative multimedia content items; and
means for adaptively providing the original or derivative multimedia content items to the remote devices by initially providing currently available original or derivative multimedia content items that most closely match the properties of the remote devices, then providing the new derivative multimedia content items as the new derivatives become available.

27. The system of claim 26, further comprising means for organizing the original and derivative multimedia content items in folders, each folder including one of the original multimedia content items and derivative multimedia content items that are derived from the original multimedia content item.
